(19) United States
(12) Patent Application Publication
(10) Pub. No.: US 2010/0285227 A1
(43) Pub. Date: Nov. 11, 2010

(54) METHOD FOR APPLYING A COATABLE MATERIAL

(76) Inventors: Robert A. Yapel, Oakdale, MN (US); Thomas J. Ludemann, Maplewood, MN (US); Larry D. Boardman, Woodbury, MN (US); Naiyong Jing, Woodbury, MN (US)

Correspondence Address: 3M INNOVATIVE PROPERTIES COMPANY, PO BOX 33427, ST. PAUL, MN, 55133-3427, US

(21) Appl. No.: 12/811,105

(22) PCT Filed: Dec. 8, 2008
(86) PCT No.: PCT/US08/85829

§ 371 Date: Jun. 29, 2010

Related U.S. Application Data
(60) Provisional application No. 61/018,062, filed on Dec. 31, 2007.

(51) Int. Cl. B05D 1/28; B05D 1/30

(52) U.S. Cl. 427/420; 427/428.01; 118/200

(57) ABSTRACT

The present disclosure describes a method for applying a coatable material to a substrate. Further, a method for treating a coating apparatus is described. At least one treated surface is coated with a low surface energy material having a thickness less than 5 micrometers.

### FIELD

The present disclosure relates to a coating apparatus, a method for treating a coating apparatus and a method for applying a coatable material.

### BACKGROUND

The process of applying or coating liquids onto substrates or webs is known. However, the process can be complex depending on the liquid and the substrate used, on the performance objectives of the end product, and on the process itself. Many coating apparatus and coating process variations have been developed to address specific coating needs.

Low surface energy coatings have been applied to articles. Coating apparatuses having low surface energy coatings and application methods have been described in U.S. Pat. No. 5,998,549 (Milbourn et al.) and U.S. Pat. No. 6,231,929 (Milbourn). Techniques for applying low surface energy coatings to the surfaces of coating apparatuses include grinding, abrading and high temperature curing operations.

### SUMMARY

The present disclosure describes a method for applying a coatable material to a substrate. A method for treating a coating apparatus and a coating apparatus are also described. At least one treated surface of the coating apparatus is coated with a low surface energy material having a thickness less than 5 micrometers.

In a first aspect, a method is provided for applying a coatable material to a substrate. The method includes providing a coating apparatus for dispensing the coatable material onto the substrate. The coating apparatus comprises at least one treated surface. The treated surface is coated with a low surface energy material having a thickness of less than 5 micrometers. The method includes directing the coatable material over the treated surface of the coating apparatus, and dispensing the coatable material from the coating apparatus onto the substrate.

In a second aspect, a method for treating a coating apparatus is provided. The method includes providing a coating apparatus having at least one surface and applying a low surface energy coating to at least one surface of the coating apparatus. The low surface energy coating has a thickness of less than 5 micrometers.

In a third aspect, a coating apparatus for applying a coatable material to a substrate is provided. The coating apparatus comprises at least one treated surface. The treated surface comprises a low surface energy coating having a thickness of less than 5 micrometers.

### BRIEF DESCRIPTION OF THE DRAWINGS

FIG. 1 illustrates a cross-sectional view of a slot die coater.

FIG. 2 illustrates a cross-sectional view of a slide coater.

### DETAILED DESCRIPTION

Although the present disclosure is herein described in terms of specific embodiments, it will be readily apparent to those skilled in the art that various modifications, rearrangements, and substitutions can be made without departing from the spirit of the invention.

The recitation of numerical ranges by endpoints includes all numbers subsumed within that range (e.g., 1 to 5 includes 1, 1.5, 2, 2.75, 3, 3.8, 4, and 5).

As included in this specification and the appended claims, the singular forms “a”, “an”, and “the” include plural referents unless the content clearly dictates otherwise. Thus, for example, reference to a composition containing “a compound” includes a mixture of two or more compounds. As used in this specification and appended claims, the term “or” is generally employed in its sense including “and/or” unless the content clearly dictates otherwise.

Unless otherwise indicated, all numbers expressing quantities or ingredients, measurement of properties and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present disclosure. At the very least, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains errors necessarily resulting from the standard deviations found in their respective testing measurements.

A coating apparatus having at least one treated surface is described. A low surface energy material is coated onto at least one surface of the coating apparatus to provide a treated surface. The treated surface is coated with a low surface energy material having a thickness of less than 5 micrometers.

Coating apparatuses are known in the art for applying coatable materials or liquids to substrates. Some examples of coating apparatuses include a curtain coater, a slide coater, a slot die coater, a fluid bearing coater, a slot fed knife coater, and combinations of two or more of the foregoing. Further examples of coating apparatuses can be found in Cohen, E. and Gutoff, E., Modern Coating and Drying Technology, VCH Publishers, New York (1992) and Gutoff, E. and Cohen, E., Coating and Drying Defects: Troubleshooting Operating Problems, Wiley Inter-Science, New York.

In some embodiments, a low surface energy material can be applied to the coating apparatus (e.g., slot die coater) having one or more of the components including, but not limited to, the die inlet, internal channel and die outlet or combinations thereof. Other components, not listed, of coating apparatuses may be coated with the low surface energy material such that the coatable material is directed over or adjacent to the low surface energy material. The low surface energy material applied to form a low surface energy coating on the coating apparatus can provide for enhanced performance of the coating apparatus with respect to an increase in coating speed. The low surface energy coating can minimize wetting of the surfaces of the coating apparatus by the coatable material. In one embodiment, fluorinated materials applied to surfaces of a coating apparatus can provide a way to reduce streaking and coating defects during the application of coatable materials to a substrate.

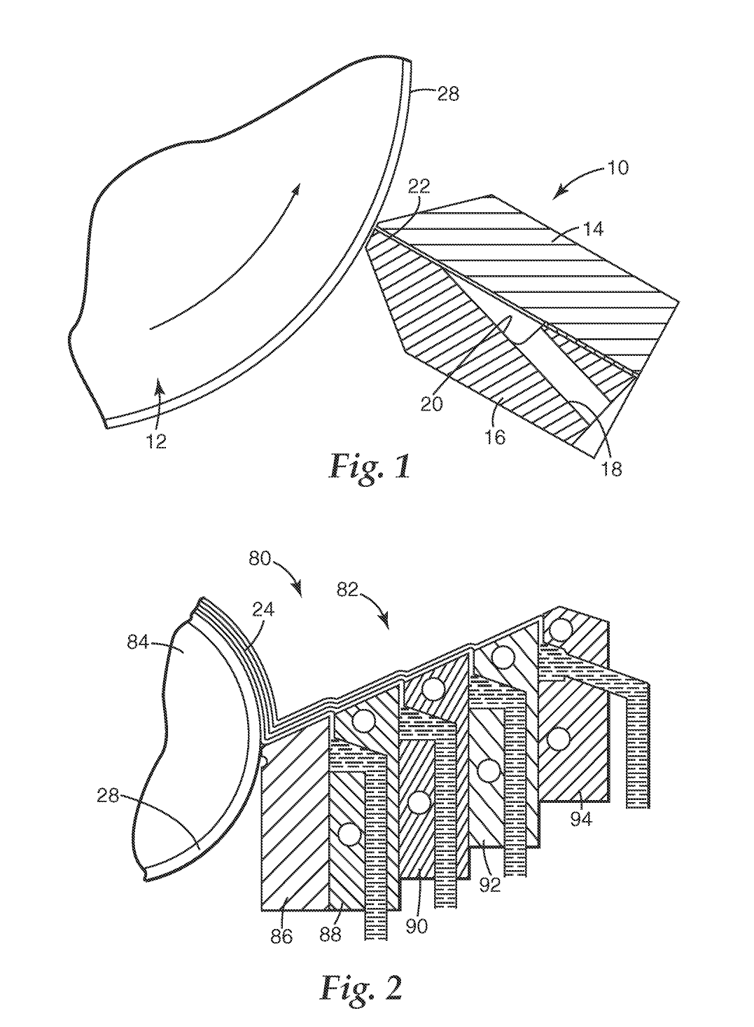

FIG. 1 shows a coating apparatus in the form of an extrusion die or slot die coater 10. The slot die coater 10 is positioned relative to a back-up roll 12. The slot die coater 10 includes a die top 14, and a die body 16 which can be made of, for example, 15-5 stainless steel. A die inlet 18, a die manifold or internal channel 20, and a die outlet 22 are formed between the die top 14 and the die body 16. A low surface energy material may be applied to at least one of the die inlet 18, the internal channel 20 and the die outlet 22.

A liquid or coatable material, such as a solution, mixture, dispersion, or emulsion can be supplied by a pump or other means to the slot die coater 10 for application to a web or a substrate 28 (e.g., a nonwoven web). The coatable material can flow through the die inlet 18, into and through the internal channel 20 and then exiting through the die outlet 22 for distribution onto the substrate 28.

During application of a coatable material with a slot die coater 10, the coatable material passes through the die outlet 22 and forms a continuous coating bead along the upstream die lip of die body 16, the downstream die lip of die top 14 and the substrate 28. The coatable material or liquid can be one of numerous coatable materials that include liquids, such as water-based liquids, organic solvent-based liquids, and 100 percent solids fluids.

The upstream or downstream lips of the die body 16 and the die top 14, for example, can be formed as sharp edges, or can be more rounded, for instance, as a result of polishing so that the upstream and downstream lips are clean and relatively free of nicks and burrs.

One or more internal surfaces of the coating apparatus are coated with a low surface energy material to minimize wetting of the coatable material on the stainless steel or metal portions of the coating apparatus. Some of the internal surfaces, for example, include portions of the die inlet, the internal channel and the die outlet. The low surface energy coating can reduce the formation of streaks and defects during dispensing of a coatable material onto a web or substrate 28. The low surface energy coating can also withstand abrasion and impacts which occur in use.

FIG. 2 shows a coating apparatus in the form of a slide coater 80. The slide coater 80 includes a slide assembly 82 and a slide back-up roll 84. The slide assembly 82 includes a number of slide blocks 86, 88, 90, 92, 94 which can simultaneously deliver multiple layers of liquid 24 to the substrate 28. A low surface energy material may be applied to the top surface of the last slide block 94 to provide a low surface energy coating to minimize the wetting of the top surface by the liquid 24 flowing down the slide coating apparatus. A low surface energy material may also be applied to a surface of the first slide block 86.

Portions of the edge guides of slide blocks 86, 88, 90, 92 which can be positioned to guide the liquid toward the back-up roll 84 and the web 28 can be treated with low surface energy coatings. If the edge guides are made of stainless steel, the edge guides can be coated without roughening or priming the surface. The low surface energy material can be directly applied to a plastic material. The presence of the low surface energy coating on the portions of the edge guides which contact the coating fluid 24 can also minimize the wetting of the edge guides or a portion thereof.

In some embodiments, the low surface energy material may be applied to at least one surface of a coating apparatus to provide a treated surface. In some embodiments, the low surface energy coating has a thickness of a molecule thick (e.g., self assembled monolayer) or on the order of 25 angstroms to 100 angstroms coated on the coating apparatus. In other embodiments, the thickness of the low surface energy coating on the coating apparatus is a monolayer. Generally, the thickness of the low surface energy material applied to the coating apparatus is sufficient not to disrupt the delivery of the coatable material to the substrate, or to impede the flow of the coatable material as it enters and exits the coating apparatus. Low surface energy materials for use in the present invention can generally be applied directly to the surface of a coating apparatus without need for significant surface preparation such as grinding of the surface prior to application of the coating, for example. The range of coating thicknesses on at least one of the components of the coating apparatus can be in a range of 25 angstroms to 4 micrometers, 100 nanometers to 3 micrometers, 200 nanometers to 2 micrometers, or 250 nanometers to 1 micrometer.

Low surface energy materials have been applied to substrates and other articles. Some examples of low surface energy materials for treating coating apparatuses include fluorinated organophosphonic acids, fluorinated phosph(on)ates, fluorinated benzotriazoles, phosphonic acid functionalized fluoropolymers, benzotriazole functionalized fluoropolymers and combinations of two or more of the foregoing.

In some embodiments, fluorinated benzotriazole is combined with a perfluoropolyether alkoxysilane to provide a low surface energy coating. Examples of perfluoropolyether alkoxysilanes are described in U.S. Pat. No. 6,231,929 (Milbourn) and U.S. Pat. No. 5,980,992 (Kistner et al.). In another embodiment, phosphonic acid functionalized fluoropolymer is combined with a multifunctional polyacrylate which is crosslinked after being dispensed onto the coating apparatus.

In one embodiment, fluorinated organophonic acids are applied to one or more surfaces on a coating apparatus. Fluorinated organophosphonic acids can be prepared by a variety of procedures (e.g., by a Michaelis-Arbuzov reaction) on the corresponding alkyl chlorides, bromides, or iodides followed by hydrolysis, as described, for example, by Bhatacharya et al. in Chemical Reviews, 81, 415-430 (1981), or by the addition of a perfluoroalkyl iodide to an olefin having the structure CH₂═CH(CH₂)ₘPO₃H, or an ester thereof, followed by reduction according to the general method of Rong et al. in Tetrahedron Letters, 31, 5615-5616 (1990). Fluorinated organophosphonic acids of Formula I have been described in U.S. Pat. No. 6,824,882 (Boardman et al.).

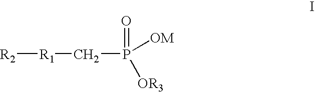

In Formula I, R₁ is a straight chain alkylene group having from about 3 to about 21 carbon atoms, an oxa-substituted straight chain alkylene group having from about 2 to about 20 carbon atoms, or a thia-substituted straight chain alkylene group having from about 2 to about 20 carbon atoms. Desirably, R₁ is a straight chain alkylene group having from about 5 to about 21 carbon atoms. Two useful straight chain alkylene groups are decane-1,10-diyl and heneicosane-1,2′-diyl. Without wishing to be bound by theory, it is believed that oxygen atoms and/or sulfur atoms, being of similar steric sized to methylene (i.e., —CH2—), may be substituted from methylene groups of the alkylene chain without significantly disrupting the self-assembling nature and/or performance characteristics of fluorinated phosphonic acids. Thus, oxa- or thia-substitution (i.e., replacement of a methylene by an O or S atom) may occur at a single site, or at multiple sites, along the alkylene chain without adverse effect.

R₂ of Formula I is a perfluoroalkyl group having from about 4 to about 10 carbon atoms with the proviso that if R₁ is an unsubstituted straight chain alkylene group, then the sum of carbon atoms in R₁ and R₂ combined is at least 10. Exemplary perfluoroalkyl groups include isomers of perfluorobutyl, perfluoropentyl, perfluorohexyl, and mixtures thereof. Desirably, R₂ is a perfluoro-n-butyl group.

R₃ of Formula I is hydrogen, an alkali metal cation (e.g., lithium, sodium, potassium), or an alkyl group having from about 1 to about 6 carbon atoms (e.g., methyl, ethyl, butyl, hexyl). Desirably, R₃ is hydrogen or an alkali metal.

M of Formula I is hydrogen or an alkali metal cation.

Fluorinated phosphonic acids of Formula I may be applied to one or more surfaces on a coating apparatus where they may form a monolayer covering on at least a portion of one of the components of the coating apparatus including, but not limited to, the die inlet, the internal channel, or the die outlet. The fluorinated phosphonic acids may be applied by contacting the surface with an amount sufficient to coat at least one surface or component of the coating apparatus. The fluorinated phosphonic acids may be dissolved in an appropriate solvent, and applied to the surface and allowed to dry to form a monolayer. Some application methods include, but are not limited to, spraying, dip coating, wiping and spin coating. The formed monolayer is typically oriented such that the phosphono group contacts the surface of the coating apparatus with the perfluoroalkyl group extending away from the substrate surface. Fluorinated phosphonic acids may be applied to the native oxide surface layer of a variety of metallic substrates, although other substrates are also useful. Some examples of metals include chromium, aluminum, copper, nickel, titanium, silver and alloys and mixtures thereof. Other materials include metal oxides and mixed metal oxides and nitrides including alumina, titania, titanium nitride, and indium tin oxide. In one embodiment, the coating apparatus comprises chromium, aluminum, copper, and/or nickel.

In another embodiment, fluorinated phosph(on)ates can be applied to coating apparatuses. Fluorinated phosph(on)ates of Formulas II-IV have been described in U.S. Pat. No. 7,189,479 (Lu et al.).

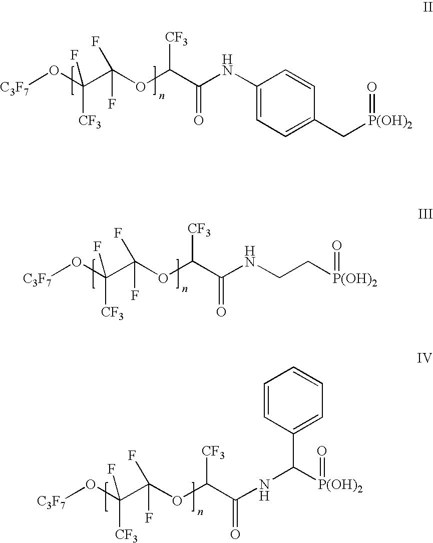

In another embodiment, fluorinated benzotriazoles of Formulas V and VI can be applied to coating apparatuses. Fluorinated benzotriazoles may form continuous monolayer films on metal or metalloid surfaces of the coating apparatuses by simply contacting the benzotriazoles with the surface to be treated. The individual molecules can pack together as densely as their molecular structures allow. It is believed that the films, in some instances, may self-assemble in that the triazole groups of the molecules attach to available areas of the metal/metalloid surface and that the pendent fluorocarbon tails are aligned substantially towards the external surface. Fluorinated benzotriazoles are described in U.S. Pat. No. 6,376,065 (Korba et al.) and U.S. Pat. No. 7,148,360 (Flynn et al).

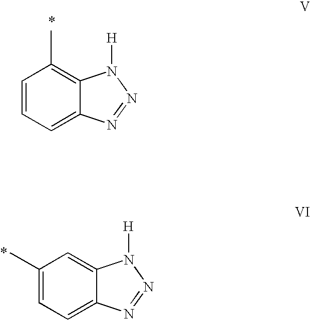

The effectiveness of a monolayer film and the degree to which a monolayer film is formed on a surface(s) of the coating apparatus is generally dependent upon the strength of the bond between the fluorinated benzotriazoles and the particular metal or metalloid surface of the coating apparatus and the conditions under which the film-coated surface is used. In some instances, some metal or metalloid surfaces may require a highly tenacious monolayer film while other such surfaces require monolayer films having much lower bond strength. Useful metal and metalloid surfaces of coating apparatuses include any surface that will form a bond with fluorinated benzotriazoles as described to coat the surface of at least one of the die inlet, the internal channel, and the die outlet of the coating apparatus. Some examples of suitable surfaces of coating apparatuses useful for forming monolayer films include those comprising copper, nickel, chromium, zinc, silver, germanium and alloys thereof.

Fluorinated benzotriazoles can be applied to coating apparatuses by contacting a surface with an amount sufficient to coat a portion or all of surface to be coated. The fluorinated benzotriazoles may be dissolved in an appropriate solvent, the composition applied to the surface, and allowed to dry. Some suitable solvents include ethyl acetate, 2-propanol, acetone, water and mixtures thereof. Alternatively, the fluorinated benzotriazoles may be deposited onto the surface of coating apparatuses from the vapor phase. Any excess fluorinated benzotriazole may be removed by rinsing the component of the coating apparatus with solvent and/or through use of the treated coating apparatus.

In some embodiments, the low surface energy material applied to a coating apparatus can increase the speed of application of a coatable material to a substrate or web. The substrate can move past a die outlet at a first speed. Coatable material can be applied to a substrate moving past the die outlet at a second speed when using a coating apparatus containing a low surface energy coating. An increase in the second speed of at least 5 percent may be observed.

In one embodiment, a die lip of a slot die coater is coated with a low surface energy material. During application of a coatable material, an increase in the contact angle between the coatable material exiting the die outlet and the substrate can occur which may contribute to an increase in coating speed. The increased contact angle may also contribute to dispensing coatable materials at larger coating gaps thus resulting in increased coating speeds. The ratio of the coating gap to the coating thickness may increase with a coating apparatus having a low surface energy coating.

In another embodiment, treatment of an internal channel of a slot die coater with a low surface energy coating can result in a reduction or near removal of bubbles entrapped in the internal channel or die manifold. A reduction in bubbles in the internal channel can improve streaking performance (e.g., a reduction in streaks/defects of the coating on the substrate).

The low surface energy coating applied to the coating apparatus can be applied without mechanical modification of the coating apparatus. The method of treating the coating apparatus of this disclosure eliminates the need for abrading, grinding, and polishing of the coating apparatus to allow for application of a low surface energy material such as polyvinylidene fluoride (PVDF). Further, curing of low surface energy materials such as PVDF at high temperatures can be reduced with the low surface energy coatings described herein. An optional primer, such as an alkoxysilane may be applied to the surface of the coating apparatus prior to the application of low surface energy materials.

1. A method for applying a coatable material to a substrate, the method comprising:
providing a coating apparatus for dispensing the coatable material onto the substrate, the coating apparatus comprising a treated surface, the treated surface coated with a layer of low surface energy material having a thickness of less than 5 micrometers;
directing the coatable material over the treated surface of the coating apparatus so that the coatable material flows over or adjacent to the layer of low surface energy material; and
dispensing the coatable material from the coating apparatus onto the substrate, wherein the layer of low surface energy material comprises a material selected from the group consisting of a fluorinated organophosphonic acid, a fluorinated benzotriazole, a fluorinated phosphonate, a fluorinated phosphate, a phosphonic acid functionalized fluoropolymer, a benzotriazole functionalized fluoropolymer, and combinations of two or more of the foregoing.

2. The method of claim 1, wherein providing a coating apparatus comprises a slot die coater, the slot die coater comprising:
a die inlet through which the coatable material is introduced to the coating apparatus;
an internal channel defined by an inner wall, the internal channel extending from the die inlet through which coatable material enters the internal channel; and
a die outlet through which the coatable material exits the internal channel to be deposited onto the substrate, the die outlet defined by at least one die lip,
wherein the treated surface is a surface of at least one of the die inlet, the internal channel, or the die outlet; and
directing the coatable material comprises directing the coatable material from the die inlet through the internal channel and through the die outlet so that the coatable material flows over or adjacent to the treated surface; and
dispensing the coatable material comprises dispensing the coatable material from the die outlet onto the substrate.

3. The method of claim 1, wherein providing a coating apparatus comprises a slide coater, the slide coater comprising:
a first slide block having a first slide surface; and
a second slide block having a second slide surface and being positioned relative to the first slide block to form a first slot therebetween through which the coatable material may flow,
wherein the treated surface is the first slide surface or the second slide surface; and
directing the coatable material comprises directing the coatable material from the first slot onto the first slide surface rather than to flow directly from the first slot over the second slide surface so that the coatable material flows over or adjacent to the first slide surface; and
dispensing the coatable material comprises dispensing the coatable material from the second slide block onto the substrate.

4. The method of claim 1, wherein the substrate is a continuous roll of material.

5. The method of claim 1, wherein the coating apparatus is selected from the group consisting of a curtain coater, a slide coater, a slot die coater, a fluid bearing coater, and a slot fed knife coater.

6. The method of claim 2, wherein the at least one die lip comprises the layer of low surface energy material.

7. The method of claim 2, wherein surfaces adjacent to the at least one die lip comprises the layer of low surface energy material.

8. The method of claim 2, wherein the internal channel comprises the layer of low surface energy material, the internal channel purged of entrapped air during directing of the coatable material.

9. (canceled)

10. (canceled)

11. (canceled)

12. (canceled)

13. (canceled)

14. The method of claim 1, wherein the fluorinated benzotriazole further comprises a perfluoropolyether alkoxysilane.

15. The method of claim 1, wherein the phosphonic acid functionalized fluoropolymer further comprises a crosslinked multifunctional acrylate.

16. (canceled)

17. A method for treating a coating apparatus, the method comprising:
providing a coating apparatus having at least one surface; and applying a layer of low surface energy material to the at least one surface of the coating apparatus, the layer of low surface energy material having a thickness of less than 5 micrometers to provide a treated coating apparatus,
wherein the layer of low surface energy material comprises a material selected from the group consisting of a fluorinated organophosphonic acid, a fluorinated benzotriazole, a fluorinated phosphonate, a fluorinated phosphate, a phosphonic acid functionalized fluoropolymer, a benzotriazole functionalized fluoropolymer, and combinations of two or more of the foregoing.

18. The method of claim 17, wherein providing a coating apparatus comprises a slot die coater, the slot die coater comprising:
a die inlet, an internal channel defined by an inner wall, and a die outlet defined by at least one die lip; and
applying a low surface energy material having a thickness of less than 5 micrometers to at least one surface of the die inlet, the internal channel, or the die outlet, to provide a treated slot die coater.

19. The method of claim 17, wherein providing a coating apparatus comprises a slide coater, the slide coater comprising:
a first slide block, and a second slide block; and
applying a low surface energy material having a thickness of less than 5 micrometers to at least one surface of the first slide block, or the second slide block, to provide a treated slide coater.

20. The method of claim 17, wherein the coating apparatus is selected from the group consisting of a curtain coater, a slide coater, a slot die coater, a fluid bearing coater, and a slot fed knife coater.

21. The method of claim 18, wherein the at least one die lip comprises the layer of low surface energy material.

22. (canceled)

23. (canceled)

24. (canceled)

25. (canceled)

26. (canceled)

27. The method of claim 17, wherein the phosphonic acid functionalized fluoropolymer further comprises a multifunctional acrylate, and further comprising a step of crosslinking the multifunctional acrylate after the applying step.

28. (canceled)

29. The method of claim 17, wherein the layer of low surface energy material has a thickness of less than 2 micrometers.

30. A coating apparatus for applying a coatable material to a substrate, the coating apparatus comprising:
at least one treated surface;
wherein at least one treated surface comprises a layer of low surface energy material having a thickness of less than 5 micrometers, and wherein the layer of low surface energy material comprises a material selected from the group consisting of a fluorinated organophosphonic acid, a fluorinated benzotriazole, a fluorinated phosph(on)ate, a phosphonic acid functionalized fluoropolymer, a benzotriazole functionalized fluoropolymer, and combinations of two or more of the foregoing.

31. The coating apparatus of claim 30, wherein the coating apparatus comprises a slot die coater, the slot die coater comprising:
a die inlet;
an internal channel defined by an inner wall, the internal channel extending from the die inlet; and
a die outlet,
wherein the at least one treated surface is a surface of at least one of the die inlet, the internal channel, or the die outlet.

32. The coating apparatus of claim 30, wherein the coating apparatus comprises a slide coater, the slide coater comprising:
a first slide block; and
a second slide block,
wherein the at least one treated surface is a surface of at least one of the first slide block or the second slide block.

33. (canceled)

34. (canceled)
